(19) United States
(12) Patent Application Publication
(10) Pub. No.: US 2023/0410834 A1
(43) Pub. Date: Dec. 21, 2023

(54) SATISFACTION ESTIMATION MODEL ADAPTING APPARATUS, SATISFACTION ESTIMATING APPARATUS, METHODS THEREFOR, AND PROGRAM

(71) Applicant: NIPPON TELEGRAPH AND TELEPHONE CORPORATION, Tokyo (JP)

(72) Inventors: Atsushi ANDO, Tokyo (JP); Hosana KAMIYAMA, Tokyo (JP); Takeshi MORI, Tokyo (JP); Satoshi KOBASHIKAWA, Tokyo (JP)

(73) Assignee: NIPPON TELEGRAPH AND TELEPHONE CORPORATION, Tokyo (JP)

(21) Appl. No.: 18/033,785

(22) PCT Filed: Nov. 4, 2020
(86) PCT No.: PCT/JP2020/041214

§ 371 Date: Apr. 25, 2023

(51) Int. Cl. G10L 25/63; G10L 15/06; G10L 15/02; G10L 15/07; H04M 3/51; H04M 3/42

(52) U.S. Cl. CPC G10L 25/63; G10L 15/063; G10L 15/02; H04M 2201/40; H04M 3/5175; H04M 3/42221; G10L 2015/0635; G10L 15/07

(57) ABSTRACT

A pre-adaptation model storage unit (14) stores a satisfaction estimation model obtained by connecting a speech satisfaction estimation model part that estimates a speech satisfaction for each speech using a feature amount of each speech as an input and a conversation satisfaction estimation model part that estimates a conversation satisfaction using at least the speech satisfaction for each speech as an input. An adaptation data storage unit (15) stores adaptation data including a conversation voice in which a conversation including a plurality of speeches is recorded and a correct value of a conversation satisfaction for the conversation. A model adaptation unit (18) fixes, by using a feature amount of each speech extracted from the conversation voice and a correct value of the conversation satisfaction, a parameter of the conversation satisfaction estimation model part to update a parameter of the speech satisfaction estimation model part.

### TECHNICAL FIELD

The present invention relates to a technique for estimating a satisfaction of the entire conversation including a plurality of speeches and a satisfaction of each speech during a conversation.

### BACKGROUND ART

For example, in an operation of a call center, there is a need for a technique for estimating customer satisfaction from conversations during a call. Here, the customer satisfaction can be indicated using a gradual category indicating whether or not the customer expresses satisfaction or dissatisfaction during a conversation, for example, by three stages such as satisfied/neutral/dissatisfied. In the present specification, in a certain call, customer satisfaction in the entire conversation is referred to as a “conversation satisfaction”, and customer satisfaction in a speech part of the customer during the conversation is referred to as a “speech satisfaction”. If the conversation satisfaction can be estimated for each call at the call center, operator evaluation can be automated, for example, by aggregating rates at which the conversation satisfaction is “satisfied” or “dissatisfied” for each operator. Further, if the speech satisfaction can be estimated for each speech during a call, for example, an application of investigating customer requests is possible by performing voice recognition and text analysis on only intervals in which the speech satisfaction is “satisfied”. Note that, although the conversation has been described here as a conversation during a call at the call center, the same can be applied to all conversations which are conducted by a plurality of speakers in a face-to-face/non-face-to-face manner.

Patent Literature 1 discloses a conventional technique for simultaneously estimating a conversation satisfaction and a speech satisfaction. In Patent Literature 1, in order to use the hierarchical dependence of the conversation satisfaction and the speech satisfaction for the estimation of each satisfaction, a simultaneous estimation model of the speech satisfaction with the conversation satisfaction (hereinafter, referred to as a “satisfaction estimation model”), which is obtained by hierarchically connecting the conversation satisfaction estimation model part and the speech satisfaction estimation model part, is used. FIG. 1 illustrates a satisfaction estimation model of Patent Literature 1. This satisfaction estimation model is configured by hierarchically connecting a speech satisfaction estimation model part that estimates the satisfaction of each speech included in a conversation to be estimated and a conversation satisfaction estimation model part that estimates the satisfaction of the entire conversation to be estimated. The speech satisfaction estimation model part includes a plurality of recurrent neural networks (RNNs) that receives the feature amount of each speech as an input and outputs an estimation result (posterior probability vector) of the satisfaction of the speech. The conversation satisfaction estimation model part includes a plurality of RNNs that receives, as an input, a speech satisfaction estimation result output by the RNN of the speech satisfaction estimation model part, and finally outputs an estimation result (posterior probability vector) of the satisfaction of the entire conversation. The speech satisfaction estimation result input from the speech satisfaction estimation model part to the conversation satisfaction estimation model part is actually a posterior probability vector including the likelihood of each category of the speech satisfaction. For example, in a case where the speech satisfaction is expressed in three stages of satisfied/neutral/dissatisfied, a three-dimensional posterior probability vector is obtained. By using this satisfaction estimation model, each satisfaction can be estimated in consideration of both the speech satisfaction indicating the partial satisfaction and the conversation satisfaction indicating the overall satisfaction, and the estimation accuracy of both the conversation satisfaction and the speech satisfaction is improved.

### CITATION LIST

### Patent Literature

Patent Literature 1: WO 2019/017462 A

### SUMMARY OF THE INVENTION

### Technical Problem

A tendency of a call is different depending on each call center. For example, in an accident reception center of an insurance company, customers tend to be quick or have a cracked voice because they are distracted by an accident. Therefore, in practical use, model adaptation is required to specialize the satisfaction estimation model for each call center.

However, in the conventional technique described in Patent Literature 1, model adaptation requires a high cost. For model adaptation, a large number of sets of conversation voices of each call center and correct labels of conversation satisfaction and speech satisfaction corresponding to each of the conversation voice are required, but the correct labels of the conversation satisfaction and the speech satisfaction must be manually assigned. Therefore, the cost of assigning a correct label to each conversation voice used for model adaptation becomes very large.

In view of the above technical problem, an object of the present invention is to reduce the cost of model adaptation for a satisfaction estimation model.

### Solution to Problem

In order to solve the above-described problems, a satisfaction estimation model adaptation apparatus according to a first aspect of the present invention includes a model storage unit that stores a satisfaction estimation model obtained by connecting a speech satisfaction estimation model part that estimates a speech satisfaction for each speech using a feature amount of each speech as an input and a conversation satisfaction estimation model part that estimates a conversation satisfaction using at least the speech satisfaction for each speech as an input, and an adaptation data storage unit that stores adaptation data including a conversation voice in which a conversation including a plurality of speeches is recorded and a correct value of a conversation satisfaction for the conversation, and a model adaptation unit that, by using a feature amount of each speech extracted from the conversation voice and a correct value of the conversation satisfaction, fixes a parameter of the conversation satisfaction estimation model part to update a parameter of the speech satisfaction estimation model part.

A satisfaction estimation apparatus according to a second aspect of the present invention includes a model storage unit that stores a satisfaction estimation model obtained by connecting a speech satisfaction estimation model part that estimates a speech satisfaction for each speech using a feature amount of each speech as an input and a conversation satisfaction estimation model part that estimates a conversation satisfaction using at least the speech satisfaction for each speech as an input, and a satisfaction estimation unit that input a feature amount of each speech extracted from a conversation voice in which a conversation including a plurality of speeches is recorded to the satisfaction estimation model to estimate a speech satisfaction for each speech and a conversation satisfaction for the conversation, in which the satisfaction estimation model fixes a parameter of the conversation satisfaction estimation model part to update a parameter of the speech satisfaction estimation model part using a feature amount of each speech extracted from a conversation voice in which a conversation including a plurality of speeches is recorded, and a correct value of a conversation satisfaction for the conversation.

### Effects of the Invention

According to the present invention, the cost of model adaptation for the satisfaction estimation model can be reduced. As a result, estimation accuracy of the conversation satisfaction and the speech satisfaction in a specific environment can be improved at low cost.

### BRIEF DESCRIPTION OF DRAWINGS

FIG. 1 is a diagram for explaining a conventional satisfaction estimation model.

FIG. 2 is a diagram for explaining a problem when fine tuning is performed using only a conversation satisfaction.

FIG. 3 is a diagram for explaining a relationship between a conversation satisfaction and a speech satisfaction at each call center.

FIG. 4 is a diagram for explaining a relationship between a conversation satisfaction and a speech satisfaction at each call center.

FIG. 5 is a diagram for explaining model adaptation using only the conversation satisfaction.

FIG. 6 is a diagram for explaining model adaptation using only the conversation satisfaction.

FIG. 7 is a diagram illustrating a functional configuration of a satisfaction estimation model learning apparatus.

FIG. 8 is a diagram illustrating a processing procedure of a satisfaction estimation model adaptation method.

FIG. 9 is a diagram illustrating a functional configuration of a satisfaction estimation apparatus.

FIG. 10 is a diagram illustrating a processing procedure of a satisfaction estimation method.

FIG. 11 is a diagram illustrating a functional configuration of a computer.

### DESCRIPTION OF EMBODIMENTS

### [Point of the Invention]

There are two points of the present invention. The first point is that model adaptation is performed only from a correct label of conversation satisfaction with a low labeling cost. The second point is to perform model adaptation of updating only some parameters of the satisfaction estimation model in order to perform the model adaptation so that the estimation accuracy of the conversation satisfaction and the speech satisfaction is improved even by only the correct label of the conversation satisfaction. Each point will be described in detail below.

Of the entire labeling cost, the cost for assigning the correct label of the speech satisfaction occupies 80% or more. This is because, while the conversation satisfaction only needs to assign one label for one conversation, the speech satisfaction needs to assign a label to all the speeches included in the conversation (which may generally be several tens of speeches) for one conversation, or the speech is too short to determine the satisfaction, and therefore it is necessary to repeatedly listen to the voice. Therefore, if the model can be adapted only from the correct label of the conversation satisfaction, it is possible to reduce the labeling cost by 80% or more.

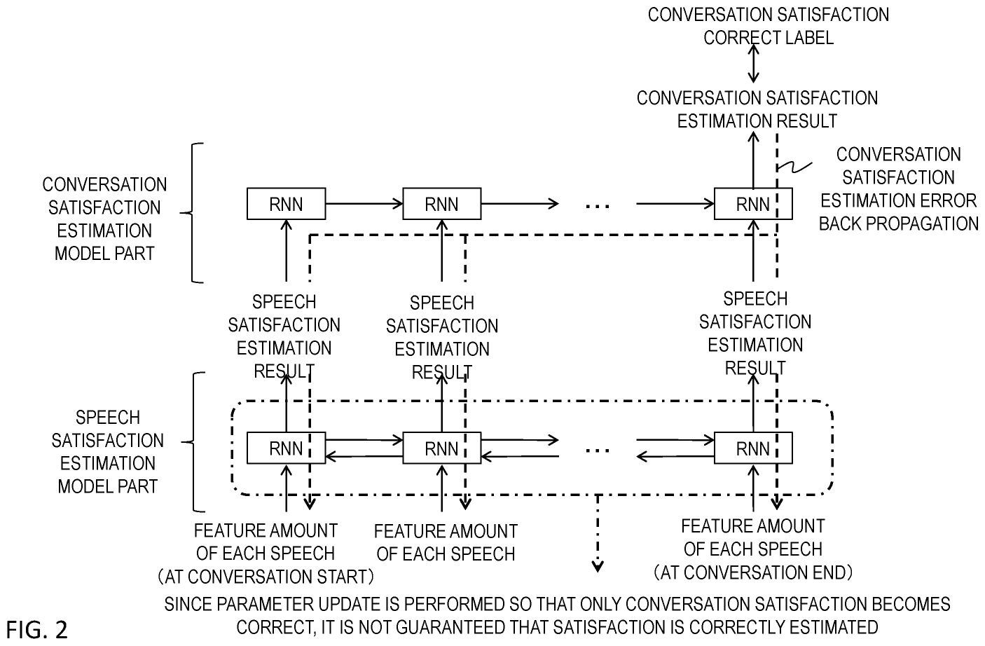

However, the estimation accuracy of the speech satisfaction may decrease only by simply applying a general model adaptation method (hereinafter, referred to as “fine tuning”) using only the conversation satisfaction label. This is because, in the fine tuning, the parameter update of the entire satisfaction estimation model is performed so as to improve only the estimation accuracy of the conversation satisfaction, and thus, it is not guaranteed that the speech satisfaction is correctly estimated (see FIG. 2). In this case, while the estimation accuracy of the conversation satisfaction is improved, the estimation accuracy of the speech satisfaction may be greatly reduced. This is inappropriate as model adaptation.

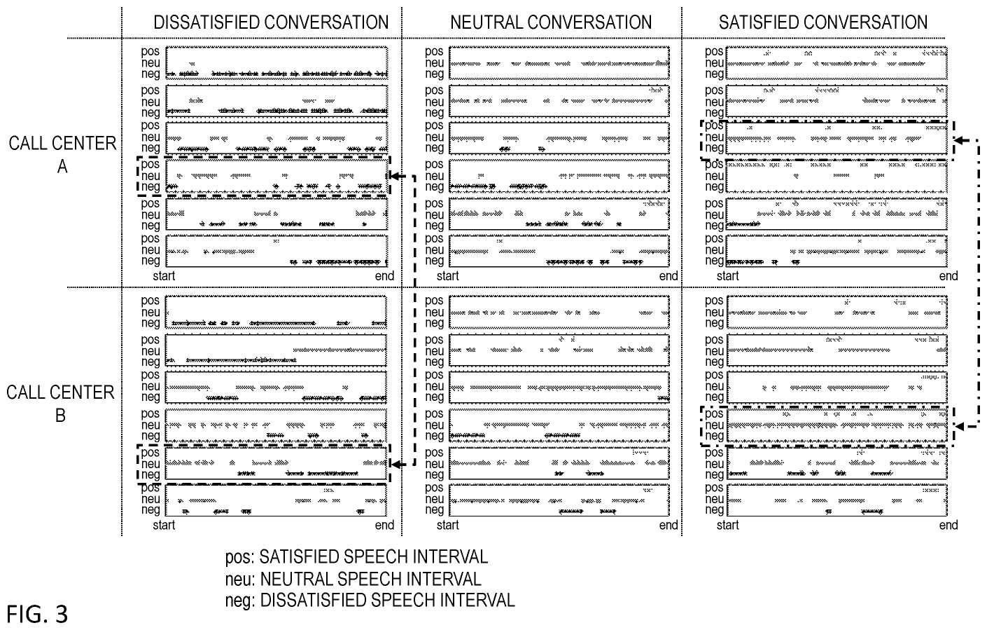

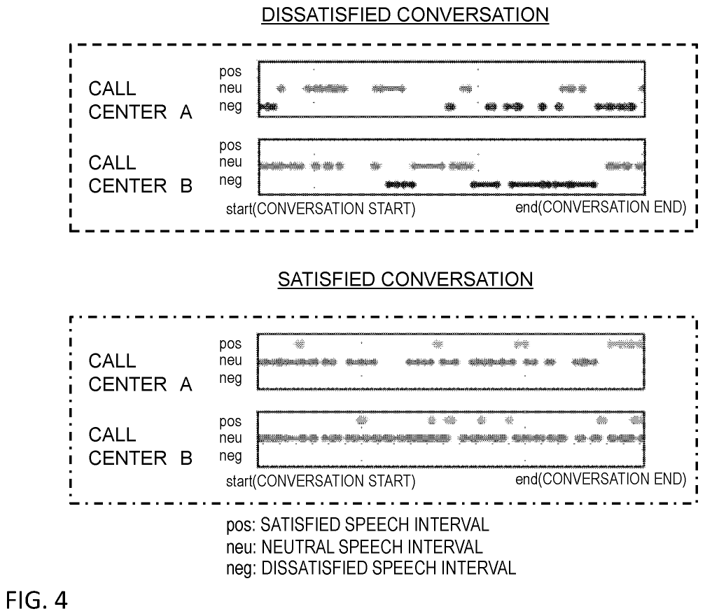

In the present invention, model adaptation using only the conversation satisfaction label is enabled by updating only some parameters of the satisfaction estimation model on the basis of the assumption that “the difference between call centers appears in the difference in the criteria for estimating the speech satisfaction from the speech, and the criteria for estimating the conversation satisfaction from the speech satisfaction are common to all the call centers”. As a result of analyzing the appearance patterns of the speech satisfaction in each of the conversation indicating the satisfaction of “Satisfied” (hereinafter, also referred to as “satisfied conversation”), the conversation indicating the satisfaction of “Neutral” (hereinafter, also referred to as “neutral conversation”), and the conversation indicating the satisfaction of “Dissatisfied” (hereinafter, also referred to as “dissatisfied conversation”) at each call center, it has been found that the appearance patterns are substantially the same in any call center. A specific example is illustrated in FIG. 3. FIG. 3 is a diagram in which a satisfied conversation/neutral conversation/dissatisfied conversation is extracted from the conversation performed in each of the two call centers (call center A, and call center B). In each conversation, a satisfied speech/neutral speech/dissatisfied speech made from the conversation start to the conversation end are plotted in time series, and the upper stage (pos) of each speech corresponds to the satisfied speech, the middle stage (neu) corresponds to the neutral speech, and the lower stage (neg) corresponds to the dissatisfied speech. FIG. 4 illustrates two dissatisfied conversations surrounded by dashed lines and two satisfied conversations surrounded by long dashed dotted lines in FIG. 3 in an enlarged manner. As indicated by the two dissatisfied conversations illustrated in FIG. 4, if a certain amount of dissatisfied speech continues in an arbitrary interval of the conversation, the dissatisfied conversation often occurs at any call center. Furthermore, as indicated by the two satisfaction conversations illustrated in FIG. 4, if the satisfied speech appears in both the middle and the final stages of the conversation, the conversation is often the satisfied conversation at any call center. Hence, the difference between call centers appears in that the criteria for estimating the speech satisfaction from the speech is different, and on the other hand, the relevance between the appearance pattern of the speech satisfaction and the conversation satisfaction may be common to any call center. Here, “the criteria for estimating the speech satisfaction from the speech is different” means that the characteristics (for example, speech speed, frequency of back-channeling, ease of appearance of gratitude words, and the like) of the speech and the criteria for classifying each speech into satisfied/neutral/dissatisfied are different at each call center.

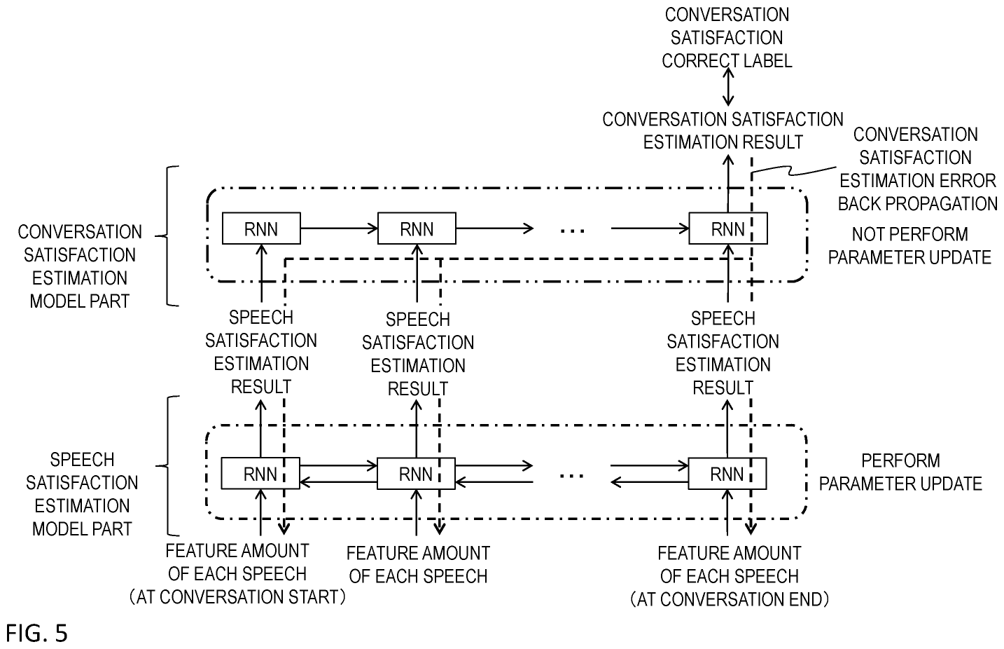

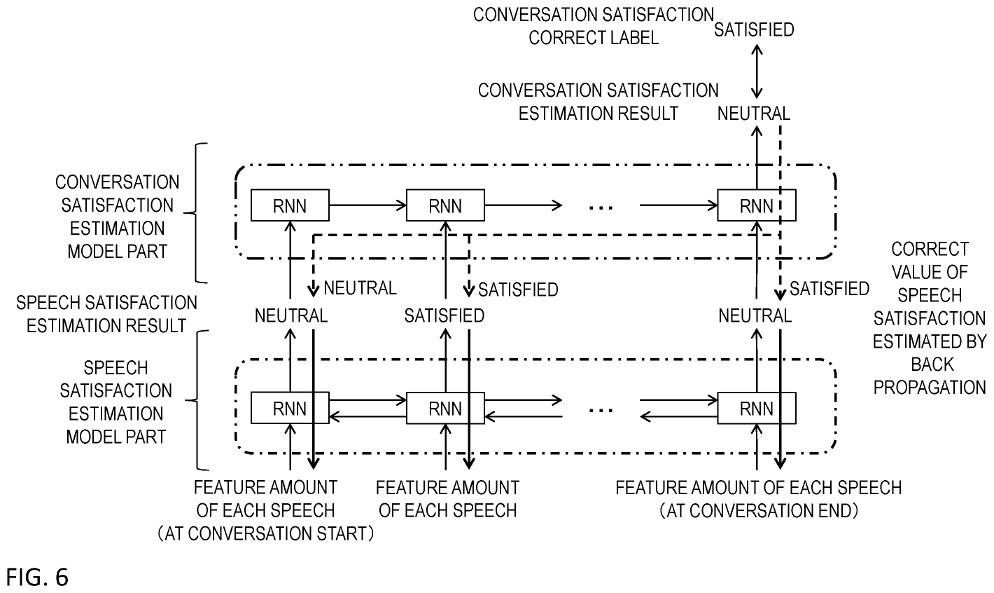

Based on this hypothesis, as illustrated in FIG. 5, in the satisfaction estimation model of the related art, the conversation satisfaction estimation model part for estimating the conversation satisfaction from the speech satisfaction estimation result does not perform parameter update, and the point of the present invention is that only the speech satisfaction estimation model part for estimating the speech satisfaction from the speech performs parameter update. In other words, model adaptation of the satisfaction estimation model is performed by fixing the parameters of the conversation satisfaction estimation model part to update the parameters of the speech satisfaction estimation model part. In a case where model adaptation is performed only from the conversation satisfaction label by this method, model adaptation is performed such that the model itself estimates a correct value of the speech satisfaction in order to increase the correct accuracy of the conversation satisfaction to update the estimation result of the speech satisfaction. A specific example is illustrated in FIG. 6. It is assumed that the satisfaction estimation model before model adaptation has been learned by using the conversation voices at various call centers, the conversation satisfaction estimation result before model adaptation is “Neutral”, and the correct label of the conversation satisfaction is “Satisfied”. In this case, since the conversation satisfaction estimation model part before the model adaptation obtains the knowledge that “if the satisfied speech appears in both the middle and the final stages of the conversation, it is the satisfied conversation”, the parameter of the conversation satisfaction estimation model part is fixed and not updated. As a result, in order to estimate the conversation satisfaction as “Satisfied”, the parameters of the speech satisfaction estimation model part are updated so as to estimate the speech satisfaction of the speech at the final stage of the conversation as “Satisfied”. That is, the satisfaction estimation model itself predicts the correct value of the speech satisfaction, and the parameters of the speech satisfaction estimation model part are updated so as to approach the estimated correct value of the speech satisfaction. As a result, the estimation accuracy of the speech satisfaction and the estimation accuracy of the conversation satisfaction can be improved only from the correct label of the conversation satisfaction.

Hereinafter, an exemplary embodiment of the invention will be described in detail. In the drawings, components having the same function are denoted by the same reference numerals, and repeated description will be omitted.

### [Satisfaction Estimation Model Learning Apparatus]

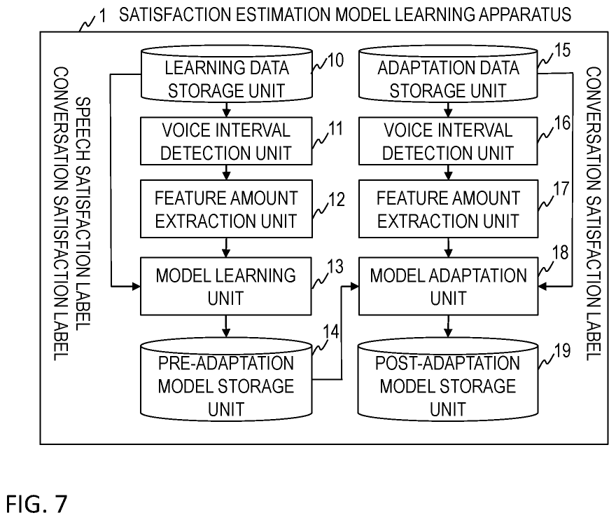

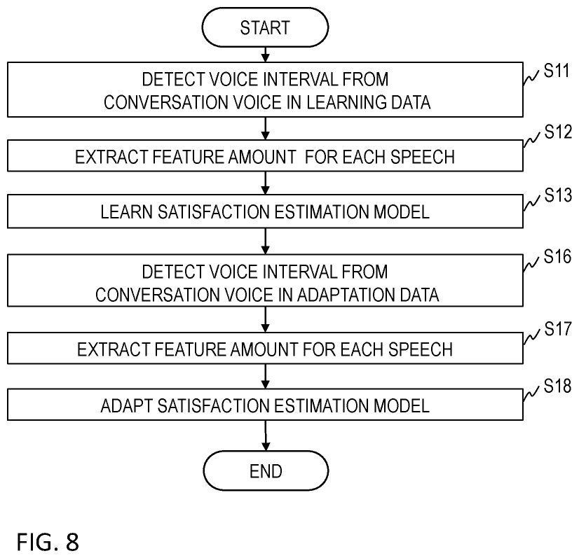

As illustrated in FIG. 7, the satisfaction estimation model learning apparatus 1 of the embodiment includes a learning data storage unit 10, a voice interval detection unit 11, a feature amount extraction unit 12, a model learning unit 13, a pre-adaptation model storage unit 14, an adaptation data storage unit 15, a voice interval detection unit 16, a feature amount extraction unit 17, a model adaptation unit 18, and a post-adaptation model storage unit 19. The satisfaction estimation model learning apparatus 1 learns the satisfaction estimation model by using the learning data stored in the learning data storage unit 10, and stores the learned satisfaction estimation model in the pre-adaptation model storage unit 14. Next, using the adaptation data stored in the adaptation data storage unit 15, model adaptation is performed on the satisfaction estimation model stored in the pre-adaptation model storage unit 14, and the satisfaction estimation model after adaptation is stored in the post-adaptation model storage unit 19. The satisfaction estimation model adaptation method of the embodiment is realized when the satisfaction estimation model learning apparatus 1 performs processing of respective steps illustrated in FIG. 8.

The satisfaction estimation model learning apparatus 1 is a special apparatus configured such that a special program is load onto a known or dedicated computer including, for example, a central processing unit (CPU), a main storage device (RAM: random access memory), and the like. For example, the satisfaction estimation model learning apparatus 1 executes each process under the control of the central processing unit. For example, data input to the satisfaction estimation model learning apparatus 1 or data obtained by each process is stored in a main storage device, and the data stored in the main storage device is read out to the central processing unit if necessary and used for other processes. At least some of respective processing units of the satisfaction estimation model learning apparatus 1 may be configured by hardware such as an integrated circuit. Each storage unit installed in the satisfaction estimation model learning apparatus 1 can be constituted by, for example, a main storage device such as a random access memory (RAM), an auxiliary storage device constituted by a hard disk, an optical disk, or a semiconductor memory device such as a flash memory, or middleware such as a relational database or a key value store. Each storage unit installed in the satisfaction estimation model learning apparatus 1 may be logically divided and may be stored in one physical storage device.

The learning data storage unit 10 stores the learning data used for learning the satisfaction estimation model from scratch. The learning data includes a conversation voice containing a conversation including at least one speech of a target speaker and at least one speech of a counterpart speaker, a label indicating a correct value of the conversation satisfaction for the conversation (hereinafter referred to as a “conversation satisfaction label”), and a label indicating a correct value of the speech satisfaction for each speech included in the conversation (hereinafter referred to as a “speech satisfaction label”). The target speaker represents a speaker who is a target of satisfaction estimation, and refers to, for example, a customer in a call at a call center. The counterpart speaker represents a speaker other than the target speaker among the speakers participating in the conversation, and refers to, for example, an operator in the call at the call center. The conversation satisfaction label and the speech satisfaction label are assigned manually in advance. The conversation satisfaction and the speech satisfaction are assumed to indicate, for example, one of three stages: satisfied/neutral/dissatisfied. It is assumed that at least one conversation voice is collected in each of a plurality of call centers as the learning data. Although the description has been given assuming that the conversation voice of the call center is handled as the object of the satisfaction estimation, the conversation voice that is the object of the present invention is not limited to the conversation voice of the call center. In the following description, an environment in which a conversation voice as the object of satisfaction estimation can be generated is referred to as a “domain”. That is, it is assumed that the learning data includes conversation voices belonging to a plurality of domains and includes at least one conversation voice for each domain.

The adaptation data storage unit 15 stores learning data (hereinafter, also referred to as “adaptation data”) used for model adaptation for the learned satisfaction estimation model. The adaptation data includes a conversation voice in which a conversation including at least one speech of the target speaker and at least one speech of the counterpart speaker is recorded, and a conversation satisfaction label for the conversation. The conversation satisfaction label is assigned manually in advance. That is, the adaptation data stored in the adaptation data storage unit 15 is different from the learning data stored in the learning data storage unit 10 in that the adaptation data does not include a speech satisfaction label.

The adaptation data is at least one conversation voice belonging to any domain (for example, a call center) for which the satisfaction estimation model is to be specialized. The domain to be subjected to the model adaptation may be a domain not included in the learning data or any domain included in the learning data. In practice, since the learning data needs to be assigned a correct label of the speech satisfaction, it is necessary to use a conversation voice not included in the learning data as the adaptation data in order to reduce the labeling cost. That is, it is desirable that the conversation voice included in the adaptation data be a conversation voice belonging to a domain not included in the learning data, or be a new conversation voice belonging to any domain included in the learning data and not included in the learning data.

Hereinafter, a satisfaction estimation model adaptation method executed by the satisfaction estimation model learning apparatus 1 of the embodiment will be described with reference to FIG. 8.

In step S11, the voice interval detection unit 11 detects a voice interval from the conversation voice stored in the learning data storage unit 10, and acquires one or more speeches of the target speaker. For example, a technique based on power thresholding can be used as a method of detecting the voice interval. Also, other voice interval detection techniques such as a technique based on a likelihood ratio of a voice/non-voice model may be used. The voice interval detection unit 11 outputs the speech of the acquired target speaker to the feature amount extraction unit 12.

In step S12, the feature amount extraction unit 12 receives the speech of the target speaker from the voice interval detection unit 11, and extracts the feature amount related to satisfaction/dissatisfaction for each speech. The feature amount extraction unit 12 outputs the extracted feature amount of each speech to the model learning unit 13. As the feature amount to be extracted, at least one or more of a prosodic feature, a conversational feature, and a linguistic feature are used.

As the prosodic feature, at least one or more of a mean, a standard deviation, a maximum value, and a minimum value of a fundamental frequency and power in speech, a speech speed in speech, and a duration of a final phoneme in speech are used. Here, the fundamental frequency and the power are obtained for each of frames into which the speech is divided. In a case in which the speech speed and the duration of the final phoneme are used, a phoneme sequence in the speech is assumed to be estimated using voice recognition.

As the conversational feature, at least one or more of a time from an immediately previous speech of the target speaker, a time from the speech of the counterpart speaker to the speech of the target speaker, a time from the speech of the target speaker to the speech of a next counterpart speaker, the length of the speech of the target speaker, lengths of previous and next speeches of the counterpart speaker, the number of back-channelings of the target speaker included in previous and next speeches of the counterpart speaker, and the number of back-channelings of the counterpart speaker included in the speech of the target speaker are used.

As the linguistic feature, at least one or more of the number of words in the speech, the number of fillers in the speech, and the number of appearances of appreciative words in the speech are used. In a case in which the linguistic feature is used, the words appearing in the speech is estimated using voice recognition, and a result thereof is used. The appreciative words are assumed to be manually selected in advance, and for example, the number of appearances of “thank you” or “thanks” is assumed to be obtained.

In step S13, the model learning unit 13 receives the feature amount of each speech from the feature amount extraction unit 12, reads the conversation satisfaction label corresponding to the conversation voice and the speech satisfaction label corresponding to each speech stored in the learning data storage unit 10, and learns the satisfaction estimation model simultaneously estimating and outputting the speech satisfaction and the conversation satisfaction using the feature amount of each speech as an input. The model learning unit 13 stores the learned satisfaction estimation model in the pre-adaptation model storage unit 14.

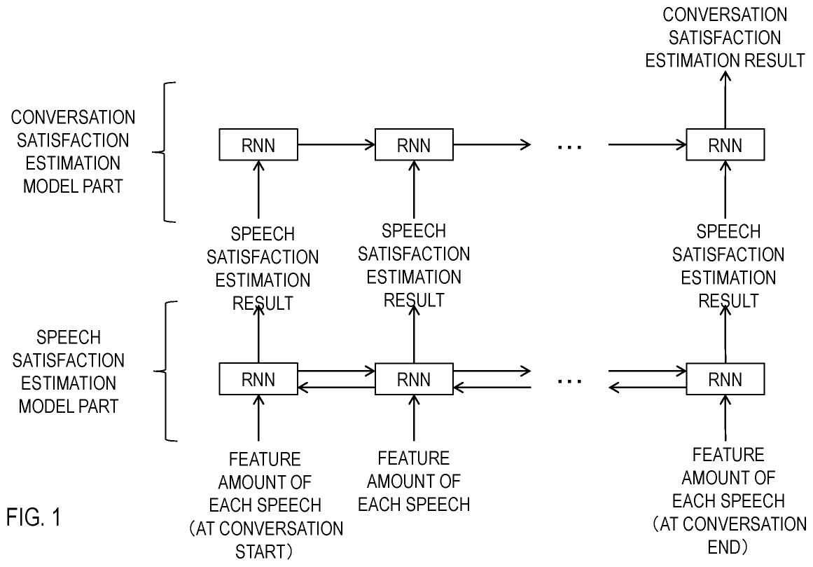

A structure of the satisfaction estimation model has been described above with reference to FIG. 1. As the recurrent neural network, for example, a long short-term memory recurrent neural network (LSTM-RNN) having one hidden layer and 128 units is used. Since the recurrent neural network is a model of performing estimation on the basis of chronological information, the speech satisfaction and the conversation satisfaction can be estimated on the basis of a temporal change in input information, and the high estimation accuracy can be expected.

As illustrated in FIG. 1, both the estimation value of the speech satisfaction for each speech and an output value of the speech satisfaction estimation model part (an output of LSTM-RNN) are used as the input of the conversation satisfaction estimation model part. Since the output value of the speech satisfaction estimation model part does not include the speech satisfaction but includes the information contributing to the estimation of the conversation satisfaction accompanied by the speech satisfaction, it is used as the input of the conversation satisfaction estimation model part.

For the learning of the satisfaction estimation model, for example, a back propagation through time (BPTT) which is a learning technique of the existing LSTM-RNN is used. Here, RNN other than the LSTM-RNN may be used, and for example, a gated recurrent unit (GRU) or the like may be used. Further, the LSTM-RNN is configured using an input gate and an output gate or using an input gate, an output gate, and an oblivion gate, and the GRU is configured using a reset gate and an update gate. In the present embodiment, a bidirectional LSTM-RNN is used, however, a unidirectional LSTM-RNN may be used. In a case in which the bidirectional LSTM-RNN is used, since information of a future speech can be used in addition to information of a past speech, the estimation accuracies of the speech satisfaction and the conversation satisfaction are improved, and it is necessary to input all speeches included in the conversation at once. In a case in which the unidirectional LSTM-RNN is used, only the information of the past speech can be used, but there is an advantage that the speech satisfaction can be estimated even during the conversation. The former is applicable to the speech analysis or the like, and the latter is applicable to real-time monitoring of customer satisfaction.

When the satisfaction estimation model is learned, the estimation error of the conversation satisfaction and the estimation error of the speech satisfaction are propagated. At this time, more robust model learning becomes possible by adjusting which of the estimation error of the conversation satisfaction and the estimation error of the speech satisfaction is more emphasized. Here, this is realized by expressing the loss function of the entire satisfaction estimation model by the loss function of the conversation satisfaction estimation model part and weighting of the loss function of the speech satisfaction estimation model part. Specifically, a loss function L of the satisfaction estimation model is indicated by the following Formula.

L=λLₜ+(1−λ)L_{c} [Math. 1]
where λ (0<λ<1) is a loss weight of the satisfaction estimation model, Lₜ is a loss function of the speech satisfaction estimation model part, and L_{c} is a loss function of the conversation satisfaction estimation model part. λ can be adjusted arbitrarily.

In step S16, the voice interval detection unit 16 detects a voice interval from the conversation voice stored in the adaptation data storage unit 15, and acquires one or more speeches of the target speaker. The conversation voice includes at least one speech of the target speaker and at least one speech of the counterpart speaker, similarly to the conversation voice of the learning data. As a method of detecting the voice interval, a method similar to that of the voice interval detection unit 11 may be used. The voice interval detection unit 16 outputs the acquired speeches of the target speaker to the feature amount extraction unit 17.

In step S17, the feature amount extraction unit 17 receives the speeches of the target speaker from the voice interval detection unit 16 and extracts the feature amount related to the satisfaction for each speech. The feature amount to be extracted may be similar to that of the feature amount extraction unit 12. The feature amount extraction unit 17 outputs the extracted feature amount of each speech to the model adaptation unit 18.

In step S18, the model adaptation unit 18 receives the feature amount of each speech from the feature amount extraction unit 17, reads the conversation satisfaction label corresponding to the conversation voice stored in the adaptation data storage unit 15, and performs model adaptation on the learned (or pre-adaptation) satisfaction estimation model stored in the pre-adaptation model storage unit 14. The model adaptation unit 18 stores the post-adaptation satisfaction estimation model in the post-adaptation model storage unit 19.

In the model adaptation unit 18, only the loss function L_{c} of the conversation satisfaction estimation is used as the loss function for parameter update. In addition, among the satisfaction estimation model before the adaptation, the parameter update is performed only for the speech satisfaction estimation model part, and the parameter update is not performed for the conversation satisfaction estimation model part. That is, model adaptation of the satisfaction estimation model is performed by fixing the parameters of the conversation satisfaction estimation model part and to update the parameters of the speech satisfaction estimation model part. In the parameter update, the loss function is calculated using the output when the conversation voice of the adaptation data is input to the satisfaction estimation model and the conversation satisfaction label of the adaptation data (that is, the correct value of the conversation satisfaction) as inputs, and each parameter is updated on the basis of the calculation result. As a method of updating the parameters of the model without updating some parameters, a known method called layer freezing can be used. This utilizes the fact that parameter update is unnecessary since the relationship between the appearance pattern of the speech satisfaction and the conversation satisfaction is the same at any call center. By fixing the parameters of the conversation satisfaction estimation model part, the satisfaction estimation model itself estimates the correct value of the speech satisfaction, and performs the parameter update of the speech satisfaction estimation model part so as to approach the estimation result of the speech satisfaction. As a result, even from only the correct label of the conversation satisfaction, the estimation accuracy of both the conversation satisfaction and the speech satisfaction can be expected to be improved.

### [Satisfaction Estimation Apparatus]

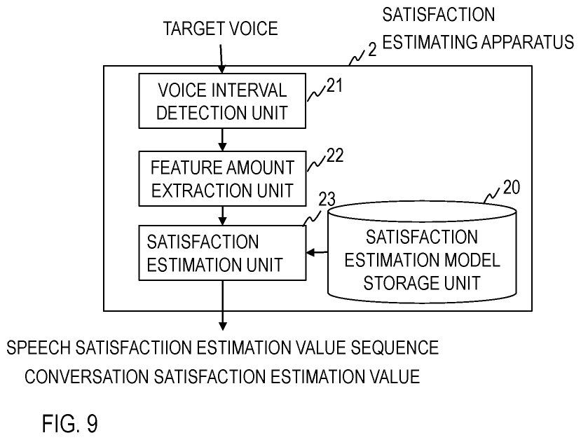

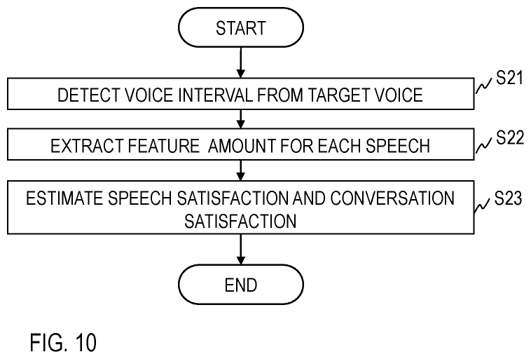

As illustrated in FIG. 9, a satisfaction estimation apparatus 2 includes a satisfaction estimation model storage unit 20, a voice interval detection unit 21, a feature amount extraction unit 22, and a satisfaction estimation unit 23. The satisfaction estimation apparatus 2 receives a conversation voice in which a voice of a conversation serving as a satisfaction estimation target is recorded as an input, estimates the speech satisfaction of each speech in the conversation and the conversation satisfaction of the conversation using the satisfaction estimation model stored in the satisfaction estimation model storage unit 20, and outputs the sequence by the estimation value of the speech satisfaction and the estimation value of the conversation satisfaction. The satisfaction estimation method of the embodiment is realized when the satisfaction estimation apparatus 2 performs processing of respective steps illustrated in FIG. 10.

The satisfaction estimation apparatus 2 is a special apparatus configured such that a special program is load onto a known or dedicated computer including, for example, a central processing unit (CPU), a main storage device (RAM: random access memory), and the like. For example, the satisfaction estimation apparatus 2 executes each process under the control of the central processing unit. For example, data input to the satisfaction estimation apparatus 2 or data obtained by each process is stored in a main storage device, and the data stored in the main storage device is read out to the central processing unit if necessary and used for other processes. At least some of respective processing units of the satisfaction estimation apparatus 2 may be configured by hardware such as an integrated circuit. Each storage unit installed in the satisfaction estimation apparatus 2 can be constituted by, for example, a main storage device such as a random access memory (RAM), an auxiliary storage device constituted by a hard disk, an optical disk, or a semiconductor memory device such as a flash memory, or middleware such as a relational database or a key value store.

The satisfaction estimation model storage unit 20 stores the post-adaptation satisfaction estimation model generated by the satisfaction estimation model learning apparatus 1.

Hereinafter, the satisfaction estimation method executed by the satisfaction estimation apparatus 2 of the embodiment will be described with reference to FIG. 10.

In step S21, the voice interval detection unit 21 detects the voice interval from the conversation voice input to satisfaction estimation apparatus 2 and acquires one or more speeches of the target speaker. The conversation voice includes at least one speech of the target speaker and at least one speech of the counterpart speaker, similarly to the conversation voice of the learning data. As a method of detecting the voice interval, a method similar to that of the voice interval detection unit 11 of the satisfaction estimation model learning apparatus 1 may be used. The voice interval detection unit 21 outputs the acquired speeches of the target speaker to the feature amount extraction unit 22.

In step S22, the feature amount extraction unit 22 receives the speeches of the target speaker from the voice interval detection unit 21 and extracts the feature amount for each speech. The feature amount to be extracted may be similar to that of the feature amount extraction unit 12 of the satisfaction estimation model learning apparatus 1. The feature amount extraction unit 22 outputs the extracted feature amount of each speech to the satisfaction estimation unit 23.

In step S23, the satisfaction estimation unit 23 receives the feature amount of each speech from the feature amount extraction unit 22, inputs the feature amount to the satisfaction estimation model stored in the satisfaction estimation model storage unit 20, and simultaneously estimates the conversation satisfaction of the conversation voice and the speech satisfaction of each speech included in the conversation voice. The satisfaction estimation model can simultaneously obtain the sequence by the estimation value of the speech satisfaction for each speech and the estimation value of the conversation satisfaction by receiving the feature amount of each speech of the target speaker as an input and performing forward propagation. The satisfaction estimation unit 23 outputs the sequence by the estimation values of the speech satisfaction for each speech and the estimation value of the conversation satisfaction from the satisfaction estimation apparatus 2.

### Modified Example

In the above embodiment, the example in which the satisfaction estimation model learning apparatus 1 and the satisfaction estimation apparatus 2 are configured as separate apparatuses has been described, but it is also possible to configure one satisfaction estimation apparatus having both a function of learning/adapting the satisfaction estimation model and a function of estimating the satisfaction using the post-adaptation satisfaction estimation model. That is, the satisfaction estimation apparatus according to the modification includes a learning data storage unit 10, a voice interval detection unit 11, a feature amount extraction unit 12, a model learning unit 13, a voice interval detection unit 16, a feature amount extraction unit 17, a model adaptation unit 18, a satisfaction estimation model storage unit 20, a voice interval detection unit 21, a feature amount extraction unit 22, and a satisfaction estimation unit 23.

In addition, in the above-described embodiment, an example has been described in which the satisfaction estimation model learning apparatus 1 having the function of learning the satisfaction estimation model from scratch and performing model adaptation on the learned satisfaction estimation model is configured as one device, however, the satisfaction estimation model learning apparatus 1 can be divided into one satisfaction estimation model learning apparatus having the function of learning the satisfaction estimation model from scratch and one satisfaction estimation model adaptation apparatus having the function of performing model adaptation on the learned satisfaction estimation model. That is, the satisfaction estimation model learning apparatus of the modification includes a learning data storage unit 10, a voice interval detection unit 11, a feature amount extraction unit 12, a model learning unit 13, and a pre-adaptation model storage unit 14. Further, the satisfaction estimation model adaptation apparatus according to the modification includes a pre-adaptation model storage unit 14, an adaptation data storage unit 15, a voice interval detection unit 16, a feature amount extraction unit 17, a model adaptation unit 18, and a post-adaptation model storage unit 19.

### [Experimental Results]

Experiments were conducted to verify the effect of the present invention. In the experiment, a conversation voice created on the basis of a scenario prepared in advance so as to include satisfied/neutral/dissatisfied in a well-balanced manner was used as learning data, and a conversation voice recorded at an actual call center was used as adaptation data. Experimental results are shown in the following table.

TABLE 1

| | | real-full | | | | real-half | | | |
|---|---|---|---|---|---|---|---|---|---|
| | | Turn | | Call | | Turn | | Call | |
| label | | Acc. | macroF1 | Acc. | macroF1 | Acc. | macroF1 | Acc. | macroF1 |
| — | No adapt | 0.466 | 0.336 | 0.533 | 0.465 | 0.466 | 0.336 | 0.533 | 0.465 |
| call + turn | Flat-start | 0.774 | 0.459 | 0.740 | 0.571 | 0.788 | 0.432 | 0.714 | 0.490 |
| | Fine-tune | 0.767 | 0.469 | 0.772 | 0.619 | 0.739 | 0.448 | 0.724 | 0.557 |
| | Call-net freezing | 0.780 | 0.474 | 0.764 | 0.606 | 0.753 | 0.457 | 0.719 | 0.568 |
| call | Fine-tune | 0.783 | 0.465 | 0.774 | 0.597 | 0.764 | 0.459 | 0.735 | 0.558 |
| | Call-net freezing | 0.801 | 0.481 | 0.780 | 0.620 | 0.793 | 0.475 | 0.738 | 0.558 |

The column “label” represents a correct label used for adaptation. “call+turn” represents that correct labels of both the conversation satisfaction and the speech satisfaction are used, and “call” represents that only correct labels of the conversation satisfaction are used. The right side of the column “label” represents an adaptation method. “No adapt” represents a case where adaptation is not performed, “Flat-start” represents a case where a model is learned from scratch using adaptation data (that is, learning data consisting of only conversation voices at a specific call center), “Fine-tune” represents a case where parameters of the entire model are updated using adaptation data with respect to a model learned using learning data (that is, learning data including conversation voices at a plurality of call centers), and “Call-net freezing” represents a case where parameters of only a speech satisfaction estimation model part are updated using adaptation data with respect to a model learned using learning data. That is, “Call-net freezing” corresponds to the configuration of the present invention. The column “real-full” is experimental results using all the conversation voices of the adaptation data, and the column “real-half” is the experimental results using the conversation voices obtained by sampling about ½ from the adaptation data. The column “Turn” is experimental results of speech satisfaction, and the column “Call” is experimental results of conversation satisfaction. “Acc.” represents an accuracy and “macroF1” represents the macro average of the F1 values.

Comparing the case of model adaptation using only the correct label of the conversation satisfaction and the case of model adaptation using the correct label of the conversation satisfaction and the speech satisfaction, it has been found that not only the estimation result of the conversation satisfaction (Call) is improved but also the estimation result of the speech satisfaction (Turn) is improved in the case of the Call-net freezing. In addition, in the case of model adaptation using only the correct label of the conversation satisfaction, comparing the Call-net freezing and the Fine-tune, the Call-net freezing has a better result than the Fine-tune except for some indexes (macroF1 of speech satisfaction (Call) when adaptation data is sampled (real-half)). This represents that the satisfaction estimation model learns the relationship between the conversation satisfaction and the speech satisfaction, and the speech satisfaction estimation result obtained by the correct label of the conversation satisfaction is modified. From this experimental result, it has been demonstrated that the conversation voice in a specific domain can be estimated with high accuracy by fixing the parameter of the conversation satisfaction estimation model part and updating the parameter of the speech satisfaction estimation model part using only the correct label of the conversation satisfaction.

### Effects of the Invention

As described above, the satisfaction estimation model learning apparatus and the satisfaction estimation apparatus of the present invention hierarchically connect the model for estimating the conversation satisfaction and the model for estimating the speech satisfaction, and are configured to perform model adaptation of updating only the parameters of the model for estimating the speech satisfaction using only the conversation voice related to a specific domain and the correct label of the conversation satisfaction in the satisfaction estimation model that simultaneously estimates the hierarchically connected model for estimating the conversation satisfaction and the model for estimating the speech satisfaction. As a result, it is possible to reduce the cost of assigning a correct label of the speech satisfaction, which conventionally accounts for 80% of the total, and thus, it is possible to improve the conversation satisfaction and the estimation accuracy of the speech satisfaction at low cost.

Although the embodiment of the present invention has been described above, a specific configuration is not limited to the above embodiment, and it goes without saying that an appropriate design change or the like not departing from the gist of the present invention is also included in the present invention. The various processes described in the embodiment are not only executed in a chronological order in accordance with the order of description but also may be executed in parallel or individually depending on a process capability of the apparatus executing the process or if necessary.

### [Program and Recording Medium]

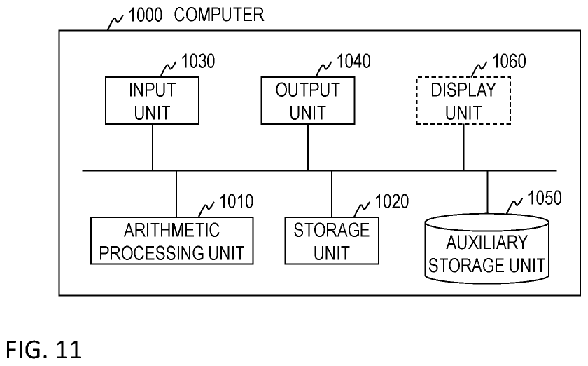

In a case in which various types of processing functions in each apparatus described in the embodiment are realized by a computer, processing content of the functions of each apparatus is described by a program. Then, by causing a storage unit 1020 of a computer illustrated in FIG. 11 to read this program and causing an arithmetic processing unit 1010, an input unit 1030, an output unit 1040, and the like to operate, various processing functions in the above devices are implemented on the computer.

The program describing the processing content can be recorded in a computer-readable recording medium. The computer-readable recording medium is, for example, a non-transitory recording medium, and is a magnetic recording device, an optical disk, or the like.

The program is distributed, for example, by selling, transferring, lending, or the like a portable recording medium such as a DVD or CD-ROM having the program recorded therein. Further, the program may be stored in a storage device of a server computer, and the program may be distributed by transferring the program from the server computer to another computer via a network.

For example, the computer that executes such a program, first, temporarily stores the program recorded in a portable recording medium or the program transferred from a server computer in an auxiliary recording unit 1050 that is a non-transitory storage device of the computer. Then, at the time of executing the processing, the computer reads the program stored in the auxiliary recording unit 1050, which is the non-transitory storage device of the computer, into the storage unit 1020, which is a temporary storage device, and executes the processing according to the read program. Also, as another execution form of the program, the computer may read the program directly from the portable recording medium and execute the process according to the program, and further the computer may execute the process according to the received program sequentially each time the program is transferred from the server computer to the computer. Further, instead of transferring the program from the server computer to the computer, the above-described process may be executed by a so-called application service provider (ASP) service of realizing the processing function in accordance with an execution instruction thereof and result acquisition. The program in the present form is assumed to include information which is provided for processing by a computer and equivalent to a program (for example, data which is not a direct command to a computer but has a property defining a process of the computer).

Also, in the present embodiment, the present apparatus is configured by executing a predetermined program on a computer, but at least some of the processing content may be realized as hardware.

With regard to the above embodiments, the following supplementary notes are further disclosed.

(Supplementary note 1)

A satisfaction estimation model adaptation apparatus, including:
a memory configured to store:
a satisfaction estimation model obtained by connecting a speech satisfaction estimation model part that estimates a speech satisfaction for each speech using a feature amount of each speech as an input and a conversation satisfaction estimation model part that estimates a conversation satisfaction using at least the speech satisfaction for each speech as an input; and
adaptation data including a conversation voice in which a conversation including a plurality of speeches is recorded and a correct value of a conversation satisfaction for the conversation; and
a processor configured to,
by using a feature amount of each speech extracted from the conversation voice and a correct value of the conversation satisfaction, fix a parameter of the conversation satisfaction estimation model part to update a parameter of the speech satisfaction estimation model part.
   (Supplementary note 2)

A satisfaction estimation model adaptation method, including:
storing, by a memory of a satisfaction estimation model adaptation apparatus, a satisfaction estimation model obtained by connecting a speech satisfaction estimation model part that estimates a speech satisfaction for each speech using a feature amount of each speech as an input and a conversation satisfaction estimation model part that estimates a conversation satisfaction using at least the speech satisfaction for each speech as an input;
storing, by a memory of the satisfaction estimation model adaptation apparatus, adaptation data including a conversation voice in which a conversation including a plurality of speeches is recorded and a correct value of a conversation satisfaction for the conversation; and
by a processor of the satisfaction estimation model adaptation apparatus, by using a feature amount of each speech extracted from the conversation voice and a correct value of the conversation satisfaction, fixing a parameter of the conversation satisfaction estimation model part to update a parameter of the speech satisfaction estimation model part.
   (Supplementary note 3)

A satisfaction estimation apparatus, including:
a memory configured to store a satisfaction estimation model obtained by connecting a speech satisfaction estimation model part that estimates a speech satisfaction for each speech using a feature amount of each speech as an input and a conversation satisfaction estimation model part that estimates a conversation satisfaction using at least the speech satisfaction for each speech as an input; and
a processor configured to input a feature amount of each speech extracted from a conversation voice in which a conversation including a plurality of speeches is recorded to the satisfaction estimation model to estimate a speech satisfaction for each speech and a conversation satisfaction for the conversation, in which
the satisfaction estimation model fixes a parameter of the conversation satisfaction estimation model part to update a parameter of the speech satisfaction estimation model part using a feature amount of each speech extracted from a conversation voice in which a conversation including a plurality of speeches is recorded, and a correct value of a conversation satisfaction for the conversation.

### (Supplementary Note 4)

A satisfaction estimation method, including:
storing, by a memory of a satisfaction estimation apparatus, a satisfaction estimation model obtained by connecting a speech satisfaction estimation model part that estimates a speech satisfaction for each speech using a feature amount of each speech as an input and a conversation satisfaction estimation model part that estimates a conversation satisfaction using at least the speech satisfaction for each speech as an input; and
inputting, by a processor of the satisfaction estimation apparatus, a feature amount of each speech extracted from a conversation voice in which a conversation including a plurality of speeches is recorded to the satisfaction estimation model to estimate a speech satisfaction for each speech and a conversation satisfaction for the conversation, in which
the satisfaction estimation model fixes a parameter of the conversation satisfaction estimation model part to update a parameter of the speech satisfaction estimation model part using a feature amount of each speech extracted from a conversation voice in which a conversation including a plurality of speeches is recorded, and a correct value of a conversation satisfaction for the conversation.
   (Supplementary note 5)

A computer-readable non-transitory storage medium storing a program for causing a computer to function as a satisfaction estimation model adaptation apparatus or a satisfaction estimation apparatus.

1. A satisfaction estimation model adaptation apparatus, comprising:
processing circuitry configured to:
store a satisfaction estimation model obtained by connecting a speech satisfaction estimation model part estimating a speech satisfaction for each speech using a feature amount of each speech as an input and a conversation satisfaction estimation model part estimating a conversation satisfaction using at least the speech satisfaction for each speech as an input;
store adaptation data including a conversation voice in which a conversation including a plurality of speeches is recorded and a correct value of a conversation satisfaction for the conversation; and
by using a feature amount of each speech extracted from the conversation voice and a correct value of the conversation satisfaction, fixe a parameter of the conversation satisfaction estimation model part to update a parameter of the speech satisfaction estimation model part.

2. The satisfaction estimation model adaptation apparatus according to claim 1, wherein
the satisfaction estimation model is learned using learning data including a conversation voice in which a conversation belonging to a plurality of domains is recorded, a correct value of a conversation satisfaction for the conversation, and a correct value of a speech satisfaction for each speech included in the conversation, and
the adaptation data includes conversation voice in which the conversation belonging to a domain not included in the plurality of domains is recorded, and the correct value of the conversation satisfaction for the conversation.

3. A satisfaction estimation apparatus, comprising:
processing circuitry configured to:
store a satisfaction estimation model obtained by connecting a speech satisfaction estimation model part estimating a speech satisfaction for each speech using a feature amount of each speech as an input and a conversation satisfaction estimation model part estimating a conversation satisfaction using at least the speech satisfaction for each speech as an input; and
input a feature amount of each speech extracted from a conversation voice in which a conversation including a plurality of speeches is recorded to the satisfaction estimation model to estimate a speech satisfaction for each speech and a conversation satisfaction for the conversation, wherein
fix a parameter of the conversation satisfaction estimation model part to update a parameter of the speech satisfaction estimation model part using a feature amount of each speech extracted from a conversation voice in which a conversation including a plurality of speeches is recorded, and a correct value of a conversation satisfaction for the conversation.

4. A satisfaction estimation model adaptation method, comprising:
storing, in processing circuitry, a satisfaction estimation model obtained by connecting a speech satisfaction estimation model part estimating a speech satisfaction for each speech using a feature amount of each speech as an input and a conversation satisfaction estimation model part estimating a conversation satisfaction using at least the speech satisfaction for each speech as an input;
storing, in the processing circuitry, adaptation data including a conversation voice in which a conversation including a plurality of speeches is recorded and a correct value of a conversation satisfaction for the conversation; and
by the processing circuitry, by using a feature amount of each speech extracted from the conversation voice and a correct value of the conversation satisfaction, fixing a parameter of the conversation satisfaction estimation model part to update a parameter of the speech satisfaction estimation model part.

5. A satisfaction estimation method, comprising:
storing, in processing circuitry, a satisfaction estimation model obtained by connecting a speech satisfaction estimation model part estimating a speech satisfaction for each speech using a feature amount of each speech as an input and a conversation satisfaction estimation model part estimating a conversation satisfaction using at least the speech satisfaction for each speech as an input; and
inputting, by the processing circuitry, a feature amount of each speech extracted from a conversation voice in which a conversation including a plurality of speeches is recorded to the satisfaction estimation model to estimate a speech satisfaction for each speech and a conversation satisfaction for the conversation, wherein
the satisfaction estimation model fixes a parameter of the conversation satisfaction estimation model part to update a parameter of the speech satisfaction estimation model part using a feature amount of each speech extracted from a conversation voice in which a conversation including a plurality of speeches is recorded, and a correct value of a conversation satisfaction for the conversation.

6. A non-transitory computer recording medium on which a program for causing a computer to operate as the satisfaction estimation model adaptation apparatus according to claim is recorded.

7. A non-transitory computer recording medium on which a program for causing a computer to operate as the satisfaction estimation model adaptation apparatus according to claim 2 is recorded.

8. A non-transitory computer recording medium on which a program for causing a computer to operate as the satisfaction estimation apparatus according to claim 3 is recorded.
